(19) United States
(12) Patent Application Publication
(10) Pub. No.: US 2007/0132962 A1
(43) Pub. Date: Jun. 14, 2007

(54) Light source assembly, and image display apparatus incorporating same

(75) Inventor: Atsushi Kitamura, Kitasaku-gun (JP)

Correspondence Address: OLIFF & BERRIDGE, PLC, P.O. BOX 19928, ALEXANDRIA, VA, 22320, US

(73) Assignee: MINEBEA CO., LTD., KITASAKU-GUN (JP)

(21) Appl. No.: 11/634,152

(22) Filed: Dec. 6, 2006

(30) Foreign Application Priority Data
Dec. 8, 2005 (JP) 2005-354942

(51) Int. Cl. G03B 21/00

(52) U.S. Cl. 353/33

(57) ABSTRACT

A light source assembly includes: a plurality of point light sources; a beam composing composite prism including a plurality of light inlet surfaces, a plurality of dichroic planes, and a light outlet surface; and an optical integrator including a plurality of light reflecting planes forming a light guide path, a light inlet end corresponding to one end of the light guide path, and a light outlet end corresponding to the other end of the light guide path. In the light source assembly, the plurality of point sources are each disposed in contact with one light inlet surface of the beam combining composite prism, and the beam combining composite prism and the optical integrator are coupled to each other such that the light outlet surface of the beam combining composite prism and the light inlet end of the optical integrator are in contact with each other.

### BACKGROUND OF THE INVENTION

1. Field of the Invention

The present invention relates generally to a light source assembly and an image display apparatus, and particularly to a light source assembly including a plurality of point light sources, and an image display apparatus incorporating such a light source assembly.

2. Description of the Related Art

Conventionally, a discharge lamp, such as an ultrahigh-pressure mercury lamp, a metal halide lamp, a xenon lamp, and the like, has been used as a light source for a projection image display apparatus (hereinafter referred to as “projector” as appropriate), such as front projector, a rear production television, and the like. Meanwhile, recently, a projector has been developed in which light emitting diodes (LEDs) of red (R), green (G) and blue (B) color are used as a light source. Such a projector contributes to reducing its structural dimension and also reportedly performs a better color reproducibility than a discharge lamp type projector (refer to, for example, Japanese Patent Application Laid-Open No. 2004-126203). Also, an LED light source has various advantages compared with the a discharge lamp light source; for example, it does not use mercury, is excellent in terms of explosion proof, is adapted to drive a battery with a comparably simple driving circuit thus making a suitable light source for a mobile projector, and so on.

FIG. 10 is a perspective view of an optical system of a conventional projector using an LED light source assembly. An optical system 100 shown in FIG. 10 includes a light source module 102, a convex lens 103, an integrator rod 104, a relay lens system 105, an image display element 106, and a projection lens 101. The light source module 102 is composed of a plurality of LEDs 121 including red, blue and green LEDs, and condenser lenses 122 arranged corresponding to respective LEDs 121. The convex lens 103 is located at a light inlet end 104a of the integrator rod 104, and the relay lens 105, which is composed of a first relay lens 151 and a second relay lens 152, is located at a light outlet end 104b of the integrator rod 104.

The optical system 100 structured as described above is adapted to improve color rendering properties and light utilization efficiency. In the optical system 100, lights emitted from the respective LEDs 121 are condensed by the corresponding condenser lenses 122 so as to be guided to the convex lens 103, converged by the convex lens 103, enter the integrator rod 104 from the light inlet end 104a, and exit out the integrator rod 104 from the light outlet 104b as a uniform light beam, the uniform light beam goes through the relay lens system 105 and impinges on the image display element 106 so as to be reflected, and the reflected light beam is projected on a screen by the projection lens 101.

In the optical system 100, since the LEDs 121 are located away from the respective condenser lenses 122 with a distance of the focal length of the condenser lens 122 allocated therebetween, and since the convex lens 103 is disposed between the condenser lens 122 and the integrator rod 104, coupling loss may possibly occur due to light leakage, and especially when the LEDs 121 have a large beam spread angle, the coupling loss is increased thus decreasing the amount of light of a projector. A coupling loss due to light leakage may further occur while a light beam from the integrator rod 104 goes through the relay lens system 105 composed of the first and second relay lenses 151 and 152 and then is guided to the image display element 106. Also, since the optical system 100 uses the lenses 122, 103, 151 and 152 which are structured discrete from the integrator rod 104, the number of components is caused to increase thus inviting cost increase and reliability degradation, and at the same time the optical system 100 is caused to increase in structural dimension thus lowering volume utilization efficiency. And, if the condenser lens 122 has a large aperture diameter for enhancing convergence efficiency of lights emitted from the LEDs 121, there arises a space constraint problem for housing the light source module 102, which makes it difficult to increase the number of the condenser lenses 122 and accordingly the number of the LEDs 121 consequently hampering the increase of the amount of light of a projector.

### SUMMARY OF THE INVENTION

The present invention has been made in light of the above problems, and it is an object of the present invention to provide a light source assembly with a small structural dimension and weight, which is provided with a function of multiplexing lights emitted from a plurality of point light sources and a function of making light uniform in coloring and intensity, and which achieves an improved efficiency of utilizing lights from the point light sources, and also to provide an image display apparatus which incorporates such a light source assembly.

In order to achieve the object of the present invention, according to one aspect of the present invention, there is provided a light source assembly which includes: a plurality of point light sources to emit lights; a beam combining composite prism including a plurality of light inlet surfaces, a plurality of dichroic planes to selectively reflect and transmit the lights emitted from the point light sources and introduced into the beam combining composite prism from the light inlet surfaces according to the wavelengths of the lights, and a light outlet surface from which a light beam combined from the lights reflected and transmitted at the dichroic planes exits out; and an optical integrator including a plurality of light reflecting planes forming a light guide path, a light inlet end corresponding to one end of the light guide path, and a light outlet end corresponding to the other end of the light guide path. In the light source assembly described above, the plurality of point light sources are each disposed in contact with one light inlet surface of the beam combining composite prism, the light outlet surface of the beam combining composite prism has a configuration substantially identical with a configuration of the light inlet end of the optical integrator, and the beam combining composite prism and the optical integrator are coupled to each other such that the light outlet surface of the beam combining composite prism and the light inlet end of the optical integrator are in contact with each other.

Since the plurality of point light sources are each disposed in contact with one light inlet surface of the beam combining composite prism, and since the beam combining composite prism and the optical integrator are coupled to each other such that the light outlet surface of the beam combining composite prism and the light inlet end of the optical integrator are in contact with each other where the contact areas of both components have almost the same configuration, the point light sources, the beam combining composite prism, and the optical integrator can be coupled together effectively without using lenses disposed discretely. Consequently, the lights emitted from the plurality of point light sources can be efficiently taken into the beam combining composite prism with an extremely small coupling loss, at the same time a volume utilization efficiency is enhanced, and the number of components is reduced, thus providing a small-size and highly reliable light source assembly.

In the aspect of the present invention, the beam combining composite prism may be substantially a cube which has one surface thereof constituting the light outlet surface and remaining five surfaces thereof constituting the light inlet surfaces, and which includes four dichroic planes to transmit a light introduced from one of the five light inlet surfaces opposite to the light outlet surface and to selectively reflect and transmit lights introduced from four of the five inlet surfaces oriented orthogonal to the light outlet surface. Accordingly, the lights emitted from up to five point light sources can be duly combined by one beam combining composite prism without adjusting the optical axis. Thus, a high-intensity light source assembly with multiple point light sources can be easily and inexpensively produced while maintaining a high volume utilization efficiency, and also lights with respective different wavelengths emitted from plural point light sources can be appropriately combined into a light having a variety of spectrum distribution.

In the aspect of the present invention, a Fresnel lens may be disposed at the light inlet end and/or the light outlet end of the optical integrator. Accordingly, the spread angle of the light emitted from the optical integrator can be optimally controlled thereby efficiently guiding the light to an optical system, such as a light modulating means, disposed at the subsequent stage.

In the aspect of the present invention, the optical integrator may be a solid structure which is formed of a light transmissive material, and which provides a refractive index distribution with respect to the direction orthogonal to the optical axis of the optical integrator. Accordingly, the spread angle of the light emitted from the optical integrator can be optimally controlled.

According to another aspect of the present invention, there is provided a light source assembly including a plurality of light source units, each of which is defined by the light source assembly described above, and which are disposed parallel to one another. Since the light source assembly as the light source unit has a comparably simple structure where the beam combining composite prism and the optical integrator are coupled into one body, a high-intensity light source assembly with multiple point light sources can be readily and inexpensively produced without requirement to adjust the optical axes while maintaining a high volume utilization efficiency only by arranging plural light source units in parallel to one another.

According to still another aspect of the present invention, there is provided an image display apparatus which includes: any one of the light source assembles described above; a light modulating means to spatially modulate a light emitted from the light source assembly according to image information; and a projection optical system to magnify and project a light coming out from the light modulating means. Since the light source assembly incorporated in the image display apparatus is reduced in dimension and weight, the image display apparatus can be reduced in dimension and weight. Also, the lights emitted from the plurality of point light sources can be efficiently taken into the beam combining composite prism with an extremely small coupling loss, and multiple point light source can be readily arranged in the light source assembly. And, since the light source assembly allows the light intensity of the light source assembly to be easily controlled by changing the number of point light sources, the image display apparatus can be freely designed to incorporate an optimal light source assembly according to the required brightness of the image projected on the screen.

Thus, the light source assembly according to the present invention is reduced in dimension and weight, has function of multiplexing the lights from the plural point light sources and function of uniforming lights, and also achieves an enhanced light utilization efficiency. And, the image display apparatus of projection type according to the present invention, which incorporates the inventive light source assembly, can be reduced in dimension and weight and achieves an increased light intensity, which makes the image display apparatus suitable for, for example, a simple mobile projector powered by a battery.

### BRIEF DESCRIPTION OF THE DRAWINGS

FIG. 1 is a perspective view of an example of a light source assembly according to a first embodiment of the present invention;

FIG. 2 is a perspective view of another example of a light source assembly according to the first embodiment;

FIG. 3 is a perspective view of a light source assembly according to a second embodiment of the present invention;

FIG. 4A is perspective view of a beam combining composite prism of the light source assembly of FIG. 3;

FIGS. 4B and 4C are exploded perspective views of the beam combining composite prim of FIG. 4A;

FIG. 5 is a perspective view of another example of an optical integrator in the present invention;

FIGS. 6A and 6B are perspective views of two examples of light source assemblies, respectively, according to a third embodiment of the present invention, wherein FIG. 6A shows an optical integrator having a Fresnel lens disposed at its light outlet end, and FIG. 6B shows an optical integrator having a Fresnel lens disposed at its light inlet end;

FIGS. 7A and 7B respectively are schematic perspective and cross sectional views of an integrator according to the present invention, which provides a refractive index distribution;

FIGS. 8A and 8B are perspective views of light source assemblies according to a fourth embodiment of the present invention, wherein FIG. 8A shows a two-unit structure, and FIG. 8B shows a four-unit structure;

FIG. 9 is a schematic view of a relevant portion of an optical system of an image display apparatus according to a fifth embodiment of the present invention; and

FIG. 10 is a perspective view of an optical system of a conventional image display apparatus.

### DETAILED DESCRIPTION OF THE INVENTION

Exemplary embodiments of the present invention will be described with reference to the accompanying drawings. The drawings are provided for explanation purpose and do not necessarily reflect actual configurations or dimensions.

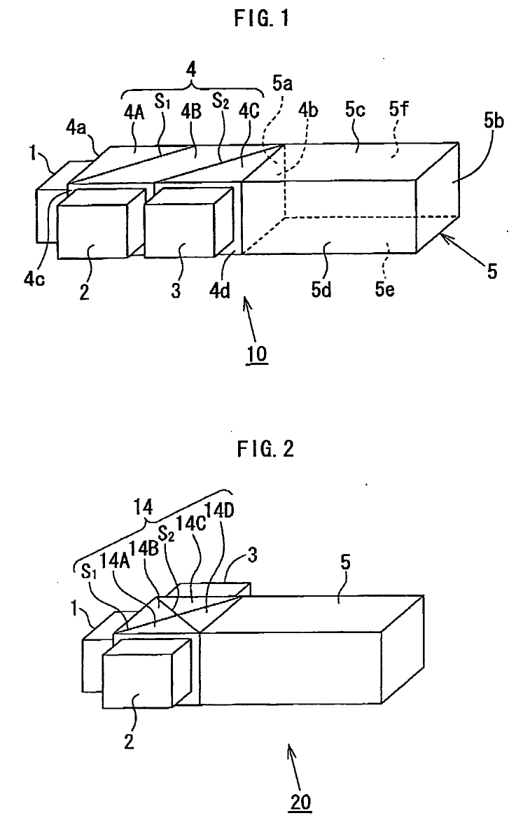

Referring to FIG. 1, a light source assembly 10 according to a first embodiment of the present invention includes a plurality (three in the figure) of point light sources 1, 2 and 3, a beam combining composite prism 4, and an optical integrator 5.

In the present embodiment, the point light sources 1, 2 and 3 are LEDs and emit lights having respective different wavelengths: for example, the point light source 1 emits a light with a first wavelength (e.g., green), the point light source 2 emits a light with a second wavelength (e.g., blue), and the point light source 3 emits a light with a third wavelength (e.g., red).

The beam combining composite prism 4 is substantially a solid rectangular column composed of three optical prisms 4A, 4B and 4C, wherein surfaces 4a, 4c and 4d each constitute a light entrance (hereinafter referred to as light inlet surface(s) as appropriate), and a surface 4b constitutes a light exit (hereinafter referred to as light outlet surface as appropriate). A dichroic plane S1 is formed at the interface between the optical prisms 4A and 4B, and a dichroic plane S2 is formed at the interface between the optical prisms 4B and 4C. The dichoric planes S1 and S2 are a dielectric multilayer film which selectively reflects and transmits lights according to the wavelength of each light. In the present embodiment, the dichoric plane S1 is adapted to reflect the light with the second wavelength emitted from the point light source 2 and to transmit the light with the first wavelength emitted from the point light source 1, and the dichroic plane S2 is adapted to reflect the light with the third wavelength emitted from the point light source 3 and to transmit the lights with the first and second wavelengths emitted respectively from the point light sources 1 and 2.

And, the optical integrator 5 includes an end plane 5a as a light entrance (hereinafter referred to as light inlet end as appropriate), an end plane 5b as a light exit (hereinafter referred to as light outlet end as appropriate), and side planes 5c, 5d, 5e and 5f as light reflecting planes, thus forming a light guide path. The optical integrator 5 may be a solid rectangular column formed of a light transmissive material, for example, a transparent resin such as acrylic resin, and polycarbonate resin, or may alternatively be a hollow rectangular column structured by four walls defining the side planes 5c, 5d, 5e and 5f.

The light outlet surface 4b of the beam combining composite prism 4 has a configuration substantially identical with the configuration of the light inlet end 5a of the optical integrator 5, and the beam combining composite prism 4 and the optical integrator 5 are fixedly coupled to each other, for example, by means of adhesion such that the light outlet surface 4b and the light inlet end 5a oppose each other. The point light sources 1, 2 and 3 are disposed in contact with the light inlet surfaces 4a, 4c and 4d, respectively, of the beam combining composite prism 4.

In the light source assembly 10 described above, lights emitted from the point light sources 1, 2 and 3, which are in contact with the light entrance surfaces 4a, 4b and 4c, immediately enter the beam combining composite prism 4, without incurring coupling loss, from the light inlet surfaces 4a, 4c and 4d, respectively, are reflected and/or transmitted by the dichoric panes S1 and S2, and are thereby combined into a light beam which is guided to the light outlet surface 4b. The combined light beam then exits out the beam combining composite prism 4 from the light outlet surface 4b, immediately enters the optical integrator 5, without coupling loss, from the light inlet end 5a directly coupled to the light outlet surface 4b of the beam combining composite prism 4, is reflected repeatedly at the side planes 5c, 5d, 5e and 5f so as to be made uniform in coloring and intensity, and exits out from the light outlet end 5b.

Thus, the light source assembly 10 is structured such that the plurality of point light sources 1, 2 and 3, the beam combining composite prism 4, and the optical integrator 5 are effectively coupled into one single body without using lenses disposed discretely, whereby the lights emitted from the point light sources 1, 2 and 3 can be utilized with an extremely small coupling loss, and also a small dimension and a high reliability are achieved.

The beam combining composite prism 4 may alternatively be structured such that a dichroic prism having a dichroic plane S1 for two wavelengths and a dichroic prism having a dichroic plane S2 for two wavelengths are connected in series to each other. Also, referring to FIG. 2, a light source assembly 20 as another example of the first embodiment includes a beam combing composite prism 14 structured into substantially a cubic body, so-called a cross cube prism, composed of four optical prisms 14A, 14B, 14C and 14D, wherein a dichroic plane S1 to reflect a light with a second wavelength and transmit lights with first and third wavelengths is diagonally formed so as to cross a dichroic plane S2 to reflect the light with the third wavelength and transmit the lights with the first and second wavelengths.

Other exemplary embodiments of the present invention than the above-described first embodiment will hereinafter be described. In the following explanations, description will be focused on the features unique to respective embodiments, and description on the common structure will be omitted as appropriate.

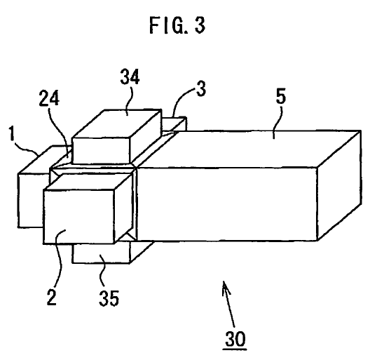

Referring to FIG. 3, a light source assembly 30 according to a second embodiment of the present invention differs from the light source assemblies 10 and 20 according to the first embodiment in that a beam combining composite prism 24 is a dichroic prism for combining five wavelengths, specifically five lights emitted from five point light sources 1, 2, 3, 34 and 35, respectively.

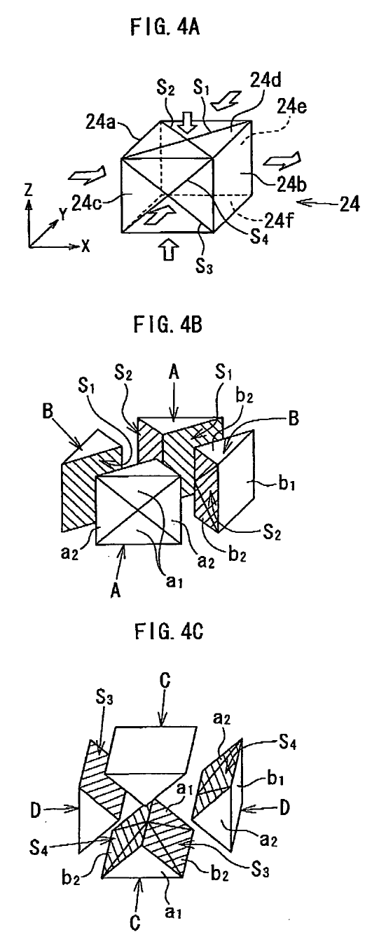

Referring to FIG. 4A, the dichoric prism as the beam combining composite prism 24 is a double cross cube prism which includes a surface 24b defined as a light outlet surface, and surfaces 24a, 24c, 24d, 24e and 24f defined as light inlet surfaces, wherein four dichroic planes S1, S2, S3 and S4 are provided which all transmit a light with a first wavelength emitted from the point light source 1 and introduced from the light inlet surface 24a opposite to the light outlet surface 24b, and which reflect and transmit, selectively according to the wavelengths, lights emitted from the point light sources 2, 3, 34 and 35 and introduced from the light inlet surfaces 24c, 24d, 24e and 24f oriented substantially orthogonal to the light outlet surface 24b: specifically, the dichroic plane S1 reflects a light with a second wavelength emitted from the point light source 2 and introduced from the light inlet surface 24c while transmitting lights with the other wavelengths, the dichroic plane S2 reflects a light with a third wavelength emitted from the point light source 3 and introduced from the light inlet surface 24e while transmitting lights with the other wavelengths, the dichroic plane S3 reflects a light with a fourth wavelength emitted from the point light source 34 and introduced from the light inlet surface 24d while transmitting lights with the other wavelengths, and the dichroic plane S4 reflects a light with a fifth wavelength emitted from the point light source 35 and introduced from the light inlet surface 24f while transmitting lights with the other wavelengths, while all of the dichroic planes S1, S2, S3 and S4 are adapted to transmit the light with the first wavelength emitted from the point light source 1 and introduced from the light inlet surface 24a.

The aforementioned first to fifth wavelengths may differ from one another, or one or some of them may be identical with other, which is appropriately determined according to the brightness, color rendering properties, and the like required for the light source assembly 30. For example, it may be arranged such that the first wavelength is green light, the second wavelength is blue light, the third wavelength is red light, the fourth wavelength is yellow green light, and the fifth wavelength is cyan light, where the entire light amount of green color is increased due to the combination of the yellow green color and the cyan color, which enables the light source assembly 30 to achieve an excellent color rendering property and a high brightness.

For explanation of one example structure of the double cross cube prism, if the beam combining composite prism 24 is broken down into four triangular column blocks A, A, B and B with the Z direction (refer to FIG. 4A) defined as the height direction as shown in FIG. 4B, the blocks A are each composed of four optical prisms, specifically a pair of optical prisms a1 and a1 and a pair of optical prisms a2 and a2, and the blocks B are each composed of three optical prisms, specifically one optical prism b1 and a pair of optical prisms b2, wherein the dichroic planes S1 and S2 which cross each other in the X-Y plane (refer to FIG. 4A) are formed at the interfaces of the four triangular blocks A, A, B and B. On the other hand, if the beam combining composite prism 24 is broken down into four triangular column blocks C, C, D and D with the Y direction (refer to FIG. 4A) defined as the height direction as shown in FIG. 4C, the blocks C are each composed of four optical prisms, specifically a pair of optical prisms a1 and a1 and a pair of optical prisms b2 and b2, and the blocks D are each composed of three optical prisms, specifically a pair of optical prisms a2 and a2 and one optical prism b1, wherein the dichroic planes S3 and S4 which cross each other in the X-Z plane (refer to FIG. 4A) are formed at the interfaces of the four triangular blocks C, C, D and D.

The light source assembly 30 according to the second embodiment, which incorporates the beam combining composite prism 24 structured into a double cross cube prism, is capable of combining lights emitted from up to five point light sources, specifically the point light sources 1, 2, 3, 34 and 35 in the present embodiment, without requirement of adjusting an optical axis, in addition to providing the advantages achieved in the first embodiment described above, whereby a high-intensity light source assembly including multiple LEDs for at least one of red, green and blue lights can be easily structured and inexpensively produced while maintaining a high volume utilization efficiency. Also, by appropriately combining the lights with respective different wavelengths emitted from the point light sources 1, 2, 3, 34 and 35, a light having a variety of spectrum distribution can be easily achieved as a combined light emitted from the beam combining composite prism 24.

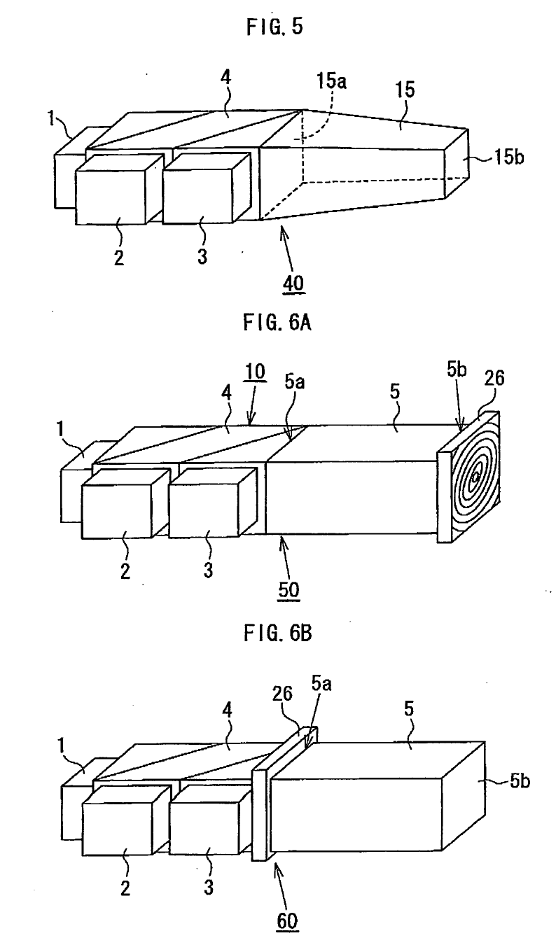

The optical integrators 5 in the light source assemblies 10, 20 and 30 shown in FIGS. 1, 2 and 3, respectively, are structured into substantially a rectangular column, but the present invention is not limited to such an optical integrator structure. For example, referring to FIG. 5, a light source assembly 40 includes an optical integrator 15 structured into a truncated rectangular pyramid such that a light inlet end 15a has a larger area than a light outlet end 15b. With such a structure, a light introduced into the optical integrator 15 are adapted to travel therethrough with an increased number of total reflections thus achieving an enhanced uniforming effect. FIG. 5 shows that the optical integrator 15 is used together with a beam combining composite prism 4 (as shown in FIG. 1) but may also be used together with a beam combining composite prism 14 (as shown in FIG. 2) or 24 (as shown in FIG. 3). Further, in the description following hereinafter, the structure of any specific light source assembly (for example, the light source assembly 10 of FIG. 1) referred to for explanation purpose can be naturally replaced with that of any of other light source assemblies (for example, the light source assembly 20, 30 or 40 shown in FIGS. 2, 3 or 5).

Referring to FIG. 6A, a light source assembly 50 according to a third embodiment of the present invention is structured basically same as the light source assembly 10 of FIG. 10 but further includes a Fresnel lens 26 disposed at a light outlet end 5b of an optical integrator 5 (preferably fixedly coupled into a single structure by adhesive). The Fresnel lens 26 is structured such that a refraction pattern including a plurality of minute circles arranged concentrically is formed on a surface of a plate-like transparent substrate so as to represent a curvilinear surface of a lens (e.g., a convex lens). With this structure, the spread angle of a combined light emitted from the optical integrator 5 can be optimally controlled. In the light source assembly 50 of FIG. 6A, the plate-like Fresnal lens 26 can be easily put together with the optical integrator 5 into a single structure thus maintaining an advantageous structure of a small dimension with a small number of components and also efficiently guiding the light emitted from the optical integrator 5 to an optical element (for example, a light modulating means to be described later) disposed at the subsequent stage.

Referring now to FIG. 6B, in a light source assembly 60 as another example of the third embodiment, a Fresnel lens 26 is disposed at a light inlet end 5a of an optical integrator 5 so as to be sandwiched between a beam combining composite prism 4 and the optical integrator 5. In this connection, a Fresnel lens 26 may be disposed at both the light inlet and outlet ends 5a and 5b of the optical integrator 5, though not illustrated.

In the light source assembly 50/60 described above, when the optical integrator 5 is a solid rectangular column of a light transmissive material, the Fresnel lens 26, which, in FIGS. 6A/6B, is a discrete component produced separately from the optical integrator 5, may alternatively be formed integrally with the optical integrator 5 at the inlet/outlet end 5a/5b.

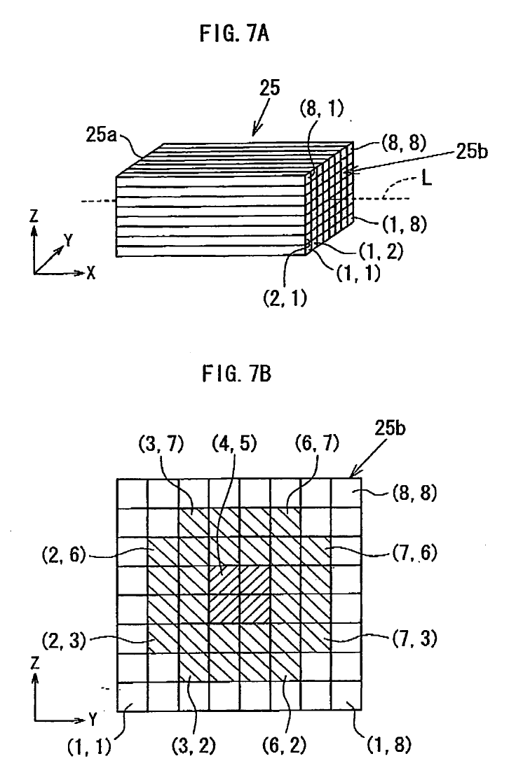

Further, an optical integrator, when formed into a solid body of a light transmissive material, can be structured to provide a refractive index distribution with respect to a direction orthogonal to its optical axis. FIGS. 7A and 7B show an optical integrator 25 as an example of such an optical integrator. FIG. 7A is a schematic perspective view of the optical integrator 25, and FIG. 7B is a schematic cross sectional view of the optical integrator 25 in the plane (Y-Z plane) orthogonal to its optical axis L.

Referring to FIGS. 7A and 7B, the optical integrator 25 is composed of a plurality (sixty four in the figures) of solid rectangular rods which are formed of a light transmissive resin and which are accumulated such that eight rods are arrayed in the Y direction and eight rods are arrayed in the Z direction. The optical integrator 25 includes a light inlet end 25a and a light outlet end 25b, and has a uniform refractive index with respect to the direction (X direction) along the optical axis L. Description an the optical integrator 25 will be made with reference to coordinates (1, 1) to (8, 8) indicated in the figures.

Referring to FIG. 7B, solid rectangular rods (4, 5), (5, 5), (4, 4) and (5, 4) shown with diagonal lines right up and located at the center are formed of a material having the highest refractive index, solid rectangular rods including (3, 7) and so on shown with diagonal lines left up and located around the rods (4, 5), (5, 5), (4, 4) and (5, 4) are formed of a material having a lower refractive index than the material of the rods (4, 5), (5, 5), (4, 4) and (5, 4), and solid rectangular rods including (1, 1) shown with no lines and located around the rods (3, 7) and so on are formed of a material having a lower refractive index than the material of the rods (3, 7) and so on thus having the lowest refractive index. With such an arrangement of the solid rectangular rods generating a refractive index distribution, a combined light introduced into the optical integrator 25 from the light inlet end 25a is adapted to converge while traveling therethrough before exiting out from the light outlet end 25b.

In the optical integrator 25, a desired refractive index distribution can be achieved by appropriately adjusting the refractive indexes of the respective solid rectangular rods. Thus, the spread angle of a light emitted from the optical integrator 25 can be optimally controlled like the spread angle of the light emitted from the optic integrator 5 provided with the Fresnel lens 26 as shown in FIGS. 6A/6B.

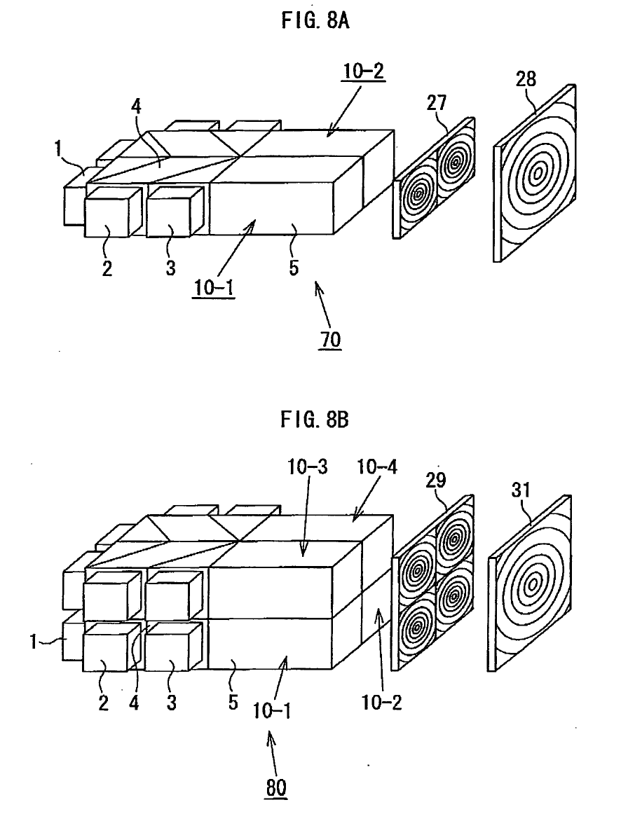

A fourth embodiment of the present invention will hereinafter be described with reference to FIGS. 8A and 8B. A light source assembly according to the fourth embodiment is composed of multiple light source units disposed in parallel to one another, where the light source assembly according to any one of the first, second and third embodiments is defined as a light source unit. FIG. 8A shows a light source assembly 70 as an example of the fourth embodiment, which includes two light source units 10-1 and 10-2 arranged in parallel to each other, and FIG. 8B shows a light source assembly 80 as another example of the fourth embodiment, which includes four light source units 10-1, 10-2, 10-3 and 10-4 arranged in parallel to one another. Since the light source units 10-1 to 10-2/10-4 are each constituted by the above-described light source assembly 10 including the plurality of point light sources 1, 2 and 3, the beam combining composite prism 4, and the optical integrator 5, which are put together into one structure without using lenses provided discretely, the light source assembly 70/80 can be readily produced by arranging the light source units 10-1 to 10-2/10-4 in parallel to one another without requirement of adjusting the optical axes. Consequently, a high-intensity light source assembly with multiple LEDs for at least one of red, green and blue lights can be easily structured and inexpensively produced while maintaining a high volume utilization efficiency.

When Fresnel lenses are used in the light source assembly 70/80, it is preferred that a multiple lens component 27/29 provided with two/four Fresnel lenses to correspond to respective light source units 10-1 to 10-2/10-4 and a Fresnel lens 28/31 sized to cover the spread lights emitted from the multiple lens component 27/29 be arranged in series to each other. It is further preferable if at least the multiple lens component 27/29 is formed integrally with the light source units 10-1 to 10-2/10-4.

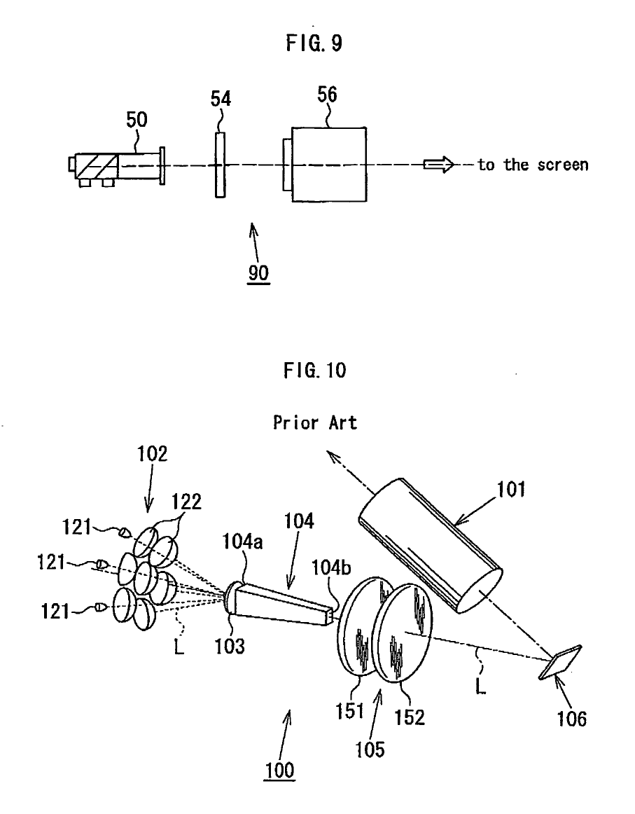

A fifth embodiment of the present invention, which refers to an image display apparatus, will hereinafter be explained with reference to FIG. 9. While FIG. 9 shows an image display apparatus incorporating the light source assembly 50 of FIG. 6A, the present invention is not limited to this arrangement, and any one of the light source assemblies described above may alternatively be used.

Referring to FIG. 9, an image display apparatus 90 includes the aforementioned light source assembly 50, a light modulating means 54 to spatially modulate a light emitted from the light source assembly 50 according to image information, and a projection optical system 56 to magnify and project a light coming out from the light modulating means 54.

The light modulating means 56 is, for example, a transmissive liquid crystal display (LCD) element adapted to control, pixel by pixel transmission and non-transmission of light according to image information sent from a driving circuit (not shown). The LCD element may include a color filter and have each of its pixels constituted by a color pixel of a red, green or blue color, or may include a color separating means (not shown), such as a dichroic mirror, provided discretely therefrom. Further, the light modulating means 56 may alternatively be a light reflection type, such as a digital micromirror device (DMD) element, with provision of a color separating means (not shown), such as a color wheel.

According to the present invention, since the light source assembly 50 is reduced considerably in dimension and weight, and since the optical system can be structured without using lenses provided discretely, the image display apparatus 90 can be reduced in dimension and weight. And, since the light source assembly 50 efficiently utilizes lights emitted from the plurality of point light sources without incurring coupling loss, and since the number of point light sources can be readily made multiple, a high-intensity image display apparatus can be readily and inexpensively produced.

What is claimed is:

1. A light source assembly comprising:
a plurality of point light sources to emit lights;
a beam combining composite prism comprising a plurality of light inlet surfaces, a plurality of dichroic planes to selectively reflect and transmit the lights emitted from the point light sources and introduced into the beam combining composite prism from the light inlet surfaces according to wavelengths of the lights, and a light outlet surface from which a light beam combined from the lights reflected and transmitted at the dichroic planes exits out; and
an optical integrator comprising a plurality of light reflecting planes forming a light guide path, a light inlet end corresponding to one end of the light guide path, and a light outlet end corresponding to the other end of the light guide path,
wherein: the plurality of point light sources are each disposed in contact with one light inlet surface of the beam combining composite prism; the light outlet surface of the beam combining composite prism has a configuration substantial identical with a configuration of the light inlet end of the optical integrator; and the beam combining composite prism and the optical integrator are coupled to each other such that the light outlet surface of the beam combining composite prism and the light inlet end of the optical integrator are in contact with each other.

2. A light source assembly according to claim 1, wherein the beam combining composite prism is substantially a cube which has one surface thereof constituting the light outlet surface and remaining five surfaces thereof constituting the light inlet surfaces, and which comprises four dichroic planes to transmit a light introduced from one of the five light inlet surfaces opposite to the light outlet surface and to selectively reflect and transit lights introduced from four of the five inlet surfaces oriented orthogonal to the light outlet surface.

3. A light source assembly according to claim 1, wherein a Fresnel lens is disposed at at least one of the light inlet end and the light outlet end of the optical integrator.

4. A light source assembly according to claim 1, wherein the optical integrator is a solid structure which is formed of a light transmissive material, and which provides a refractive index distribution with respect to a direction orthogonal to an optical axis of the optical integrator.

5. A light source assembly comprising a plurality of light source units disposed parallel to one another, each light source unit comprising:
a plurality of point light sources to emit lights;
a beam combining composite prism comprising a plurality of light inlet surfaces, a plurality of dichroic planes to selectively reflect and transmit the lights emitted from the point light sources and introduced into the beam combining composite prism from the light inlet surfaces according to wavelengths of the lights, and a light outlet surface from which a light beam combined from the lights reflected and transmitted at the dichroic planes exits out; and
an optical integrator comprising a plurality of light reflecting planes forming a light guide path, a light inlet end corresponding to one end of the light guide path, and a light outlet end corresponding to the other end of the light guide path,
wherein: the plurality of point sources are each disposed in contact with one light inlet surface of the beam combining composite prism; the light outlet surface of the beam combining composite prism has a configuration substantially identical with a configuration of the light inlet end of the optical integrator; and the beam combining composite prism and the optical integrator are coupled to each other such that the light outlet surface of the beam combining composite prism and the light inlet end of the optical integrator are in contact with each other.

6. An image display apparatus comprising:
a light source assembly as cited in claim 1;
a light modulating means to spatially modulate a light emitted from the light source assembly according to image information; and
a projection optical system to magnify and project a light coming out from the light modulating means.

7. An image display apparatus comprising:
a light source assembly as cited in claim 5;
a light modulating means to spatially modulate a light emitted from the light source assembly according to image information; and
a projection optical system to magnify and project a light coming out from the light modulating means.
